(19) United States
(12) Patent Application Publication
(10) Pub. No.: US 2023/0064646 A1
(43) Pub. Date: Mar. 2, 2023

(54) PET APPARATUS

(71) Applicant: Lara Hurst, Chandler, AZ (US)

(72) Inventor: Lara Hurst, Chandler, AZ (US)

(21) Appl. No.: 17/573,025

(22) Filed: Jan. 11, 2022

Related U.S. Application Data
(60) Provisional application No. 63/240,301, filed on Sep. 2, 2021.

(51) Int. Cl. A01K 1/03

(52) U.S. Cl. CPC A01K 1/03

(57) ABSTRACT

The disclosed apparatus for use by a pet may comprise a flexible frame and a housing configured to enclose the flexible frame. The flexible frame may be capable of being molded into a shape and may be configured to retain the shape. The housing may be configured to enclose the flexible frame and may comprise an exterior surface and an interior surface. The interior surface may define a receptacle cavity in the housing and may comprise a lining that circumscribes an edge of the frame when the frame is disposed within the receptacle cavity, wherein the lining is configured to prevent the flexible frame from penetrating the housing.

### BACKGROUND OF THE TECHNOLOGY

Various pet apparatuses, such as beds, enclosures, ramps, tents, tunnels, tubes, and other structures may be utilized by pets, such as cats, dogs, rabbits, etc. for exercise, play, or rest. Conventional pet apparatuses are typically designed for a single purpose, meaning they are designed for only one of the following: exercise, play, or rest. In this regard, conventional pet apparatuses are limited in that they cannot be bent or shaped into a variety of forms, nor do they allow for different pathways of movement, making the pets prone to boredom. In addition, conventional pet apparatuses are typically made of wood, cardboard, metal, wires, or other similar materials. Conventional pet apparatuses may also be configured in a manner where the metal, wires or other similar harmful materials may be easily exposed, making it uncomfortable and potentially unsafe for the pet to use the pet apparatus for exercise, play, or rest. Further, conventional pet apparatuses are typically made of one or more materials, such as wood, and fibers that, if ingested, may cause harm to the pet's digestive system, thereby causing pain and even death. Accordingly, there is a need for a pet apparatus that can be bent or shaped into a variety of forms and is safe for the pet to use.

### SUMMARY OF THE TECHNOLOGY

The disclosed apparatus for use by a pet may comprise a flexible frame and a housing configured to enclose the flexible frame. The flexible frame may be capable of being molded into a shape and may be configured to retain the shape. The housing may be configured to enclose the flexible frame and may comprise an exterior surface and an interior surface. The interior surface may define a receptacle cavity in the housing and may comprise a lining that circumscribes an edge of the frame when the frame is disposed within the receptacle cavity, wherein the lining is configured to prevent the flexible frame from penetrating the housing.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a perspective view of a pet apparatus in a first position in accordance with an embodiment of the present technology; and

FIG. 2 representatively illustrates a front view of a frame in accordance with a first embodiment of the present technology;

FIG. 3 representatively illustrates a perspective view of a housing in accordance with an embodiment of the present technology;

FIG. 4 representatively illustrates a perspective view of the pet apparatus illustrated in FIG. 1 in a second position;

FIG. 5 representatively illustrates a perspective view of the pet apparatus illustrated in FIG. 1 in a third position;

FIG. 6 representatively illustrates a perspective view of the pet apparatus illustrated in FIG. 1 in a fourth position;

FIG. 7 representatively illustrates a perspective view of the pet apparatus illustrated in FIG. 6 in accordance with an embodiment of the present technology;

FIG. 8 representatively illustrates a perspective view of the pet apparatus illustrated in FIG. 1 in a fifth position;

FIG. 9 representatively illustrates a font view of a frame in accordance with a second embodiment of the present technology;

FIG. 10 representatively illustrates a front view of a portion of a frame in accordance with an embodiment of the present technology;

FIG. 11 representatively illustrates a perspective view of a system for use by a pet in accordance with a first embodiment of the present technology; and

FIG. 12 representatively illustrates a front view of a system for use by a pet in accordance with a second embodiment of the present technology.

### DETAILED DESCRIPTION OF EMBODIMENTS

The present technology may be described in terms of functional block components. Such functional blocks may be realized by any number of components configured to perform the specified functions and achieve the various results. For example, the present technology may employ various flexible frames, housings, linings, materials, markings, surfaces, and the like, which may carry out a variety of functions. In addition, the present technology may be practiced in conjunction with any one of various pet apparatuses, and the pet apparatus described herein is merely one exemplary application for the technology.

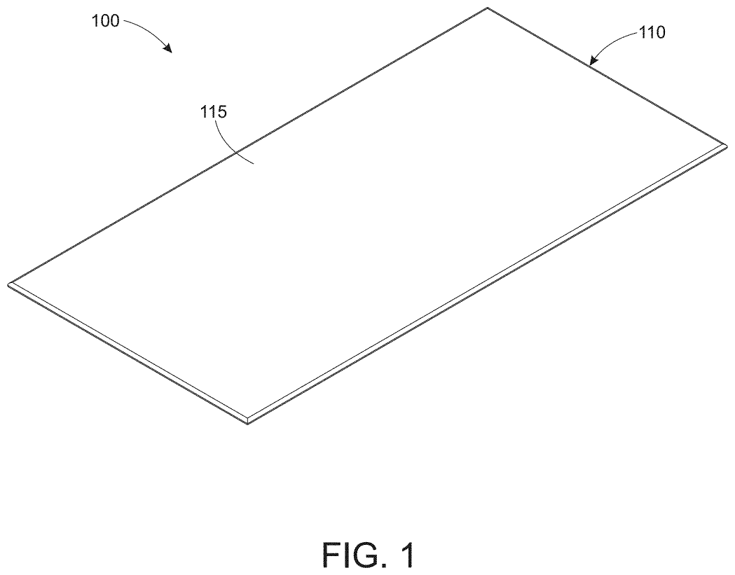

Referring to FIGS. 1-12, an exemplary apparatus 100 for use by a pet, such as a cat, chinchilla, dog, ferret, guinea pig, gerbil, hamster, hedgehog, mouse, rabbit, squirrel, and the like may be bent or shaped into a bed, enclosure, ramp, tent, tunnel, or other structure. The apparatus 100 may comprise a flexible frame 105 and a housing 110 configured to enclose the flexible frame 105.

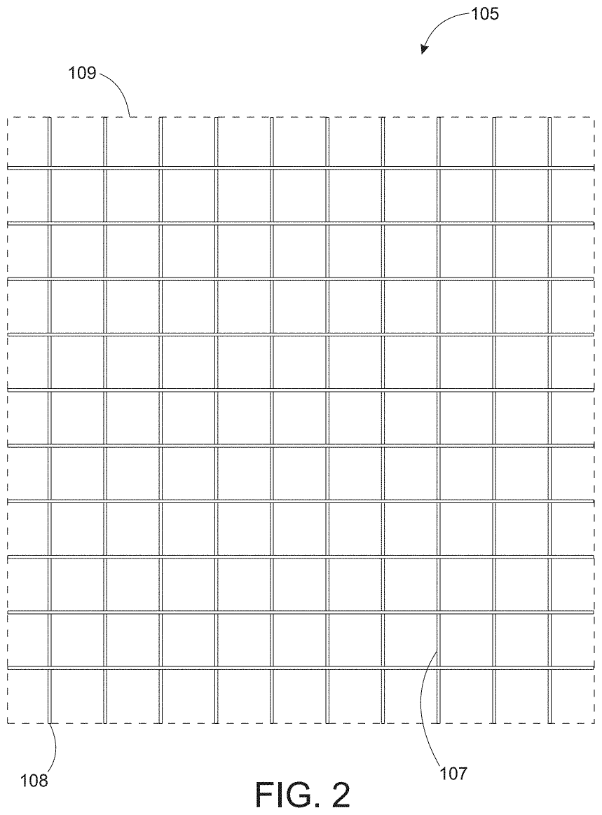

According to various embodiments, and referring now to FIG. 2, the flexible frame 105 may comprise a plurality of interconnected members 107 comprising a plurality of ends 108. The flexible frame 105 may also comprise an outer edge 109 formed by the plurality of ends 108. The plurality of interconnected members 107 may be constructed from a variety of suitable materials, such as metal, and the like. In addition, the flexible frame 105 may comprise any suitable size or shape such as a rectangular-shaped body, a square-shaped body, a circular-shaped body, or an oval-shaped body.

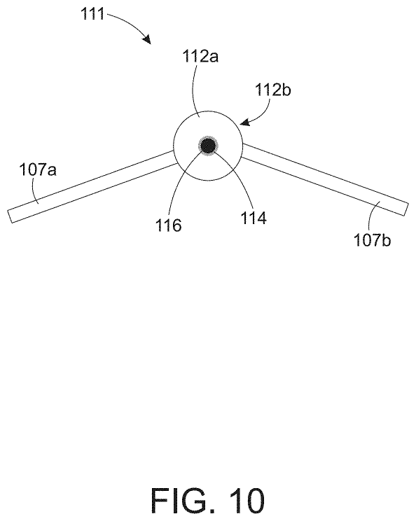

In one embodiment, the plurality of interconnected members 107 may be interwoven. In another embodiment, the plurality of interconnected members 107 may be welded to each other. In yet another embodiment, and referring now to FIG. 10, the plurality of interconnected members 107 may comprise a plurality of joints 111, where each joint 111 may comprise a first member 107a and a second member 107b. The first member 107a may comprise a first hub 112a and the second member 107b may comprise a second hub 112b, respectively. The second hub 112b may be in contact with the first hub 112a and may be axially connected to the first hub 112a. In addition, the flexible frame 105 may comprise any suitable connector 114, such as a rivet, screw, bolt, or the like. In addition, the connector 114 may comprise a locking component 116 configured to constrain a movement of the first member 107a with respect to the second member 107b.

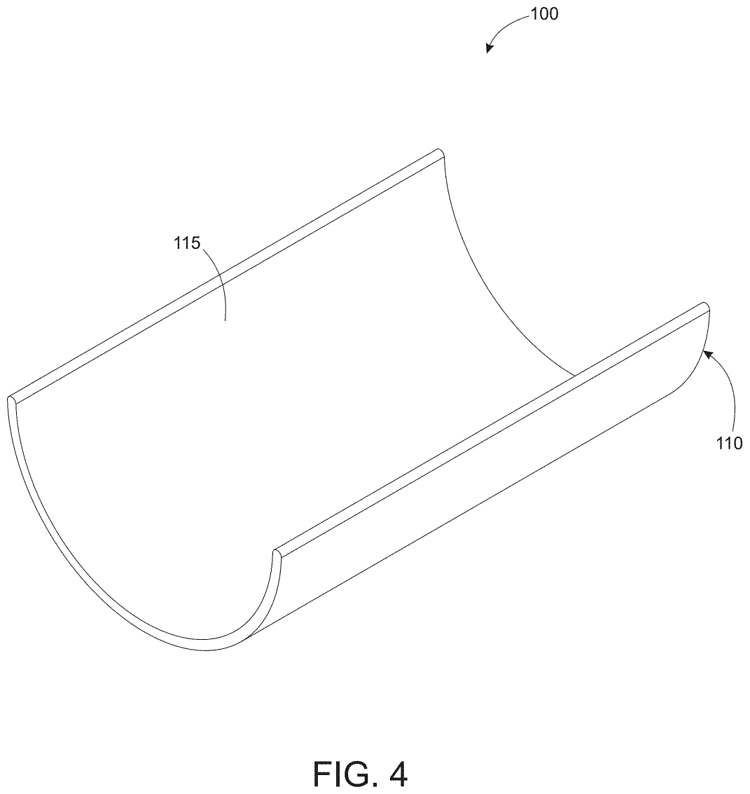

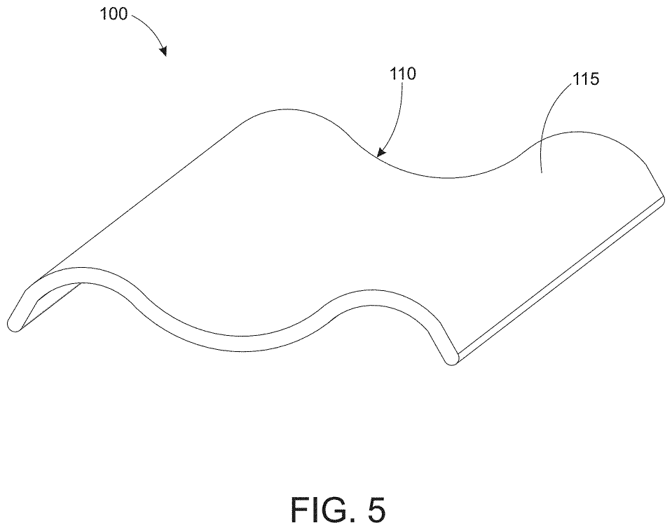

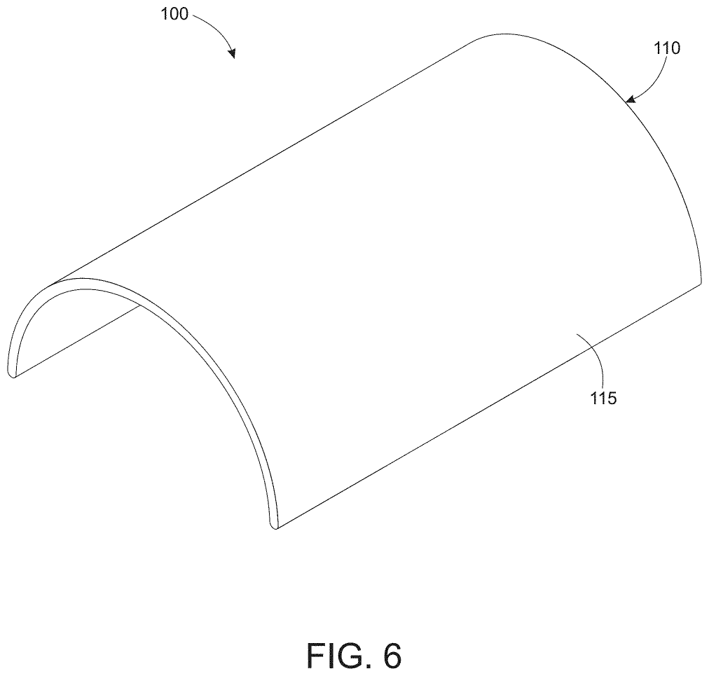

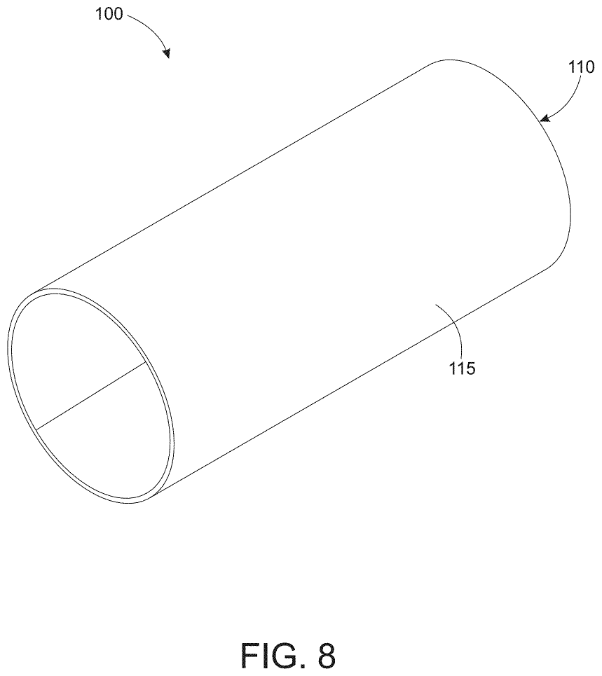

The locking component 116 may comprise any suitable device or system for locking the first member 107a to the second member 107b. The locking component 116 may also be configured to disengage the first member 107a from the second member 107b. In one embodiment, the locking component 116 may pivot between a locked position wherein a movement of the first member 107a with respect to the second member 107b may be constrained, and an unlocked position wherein the first member 107a may be disengaged from the second member 107b. Specifically, the first hub 112a may be locked to the second hub 112b until a force sufficient to overcome a frictional force resisting the motion of the first hub 112a with respect to the second hub 112b, and vice versa, is applied to the joint 111. In this regard, the flexible frame 105 may be molded into a shape, wherein the flexible frame 105 may be configured to retain the shape. Specifically, the flexible frame 105 may be bent or shaped into a variety of suitable forms, including, but not limited to, an arch, as shown in FIG. 4, a bed, as shown in FIG. 1, a ramp, as shown in FIG. 5, a tunnel, as shown in FIG. 6, or a tube, as shown in FIG. 8.

As an example, the locking component 116 may be configured to couple the first member 107a to the second member 107b in a locked position, whereby the first hub 112a is twisted into the locked position by pressing the first hub 112a towards the second hub 112b and turning the first hub 112a to lock into position. Similarly, the locking component 116 may decouple the first member 107a from the second member 107b in an unlocked position, whereby the first hub 112a is twisted into the unlocked position by turning the first hub 112a to disengage. For example, each hub 112a, 112b may comprise threads (not shown) and/or serrations (not shown). The threads (not shown) and/serrations (not shown) formed on either hub 112a, 112b may be in mating engagement with corresponding threads (not shown) and/or serrations (not shown) formed on the corresponding hub 112a, 112b, so that the first hub 112a may be coupled to the second hub 112b. The threads (not shown) and/or serrations (not shown) on each hub 112a, 112b may be formed spirally and circumferentially thereon.

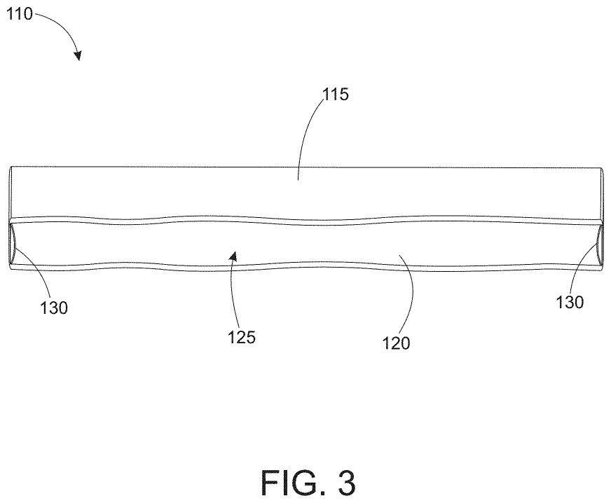

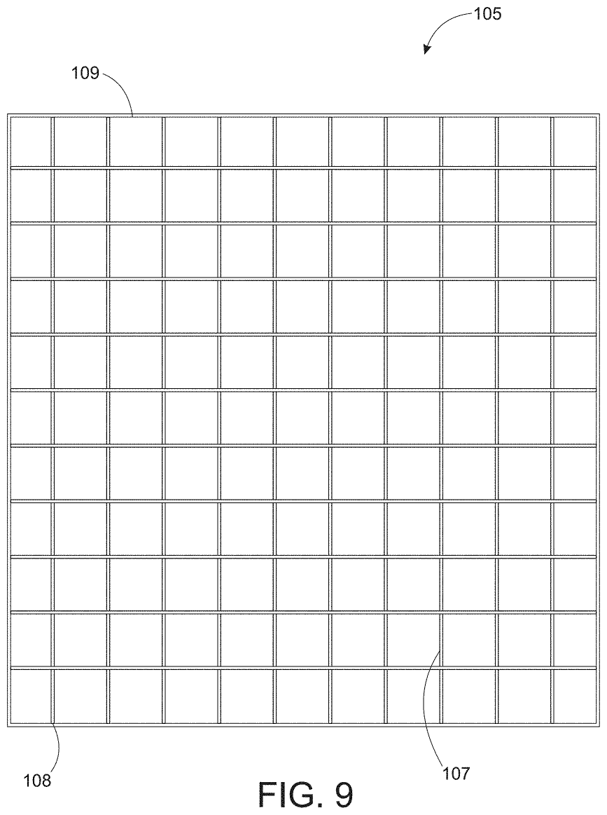

According to various embodiments, and referring now to FIGS. 2-3, the housing 110 may be configured to enclose the flexible frame 105 and may comprise an exterior surface 115 and an interior surface 120. The interior surface 120 may define a receptacle cavity 125 in the housing 110. In an exemplary embodiment, the interior surface 120 of the housing 110 may comprise a lining 130 that circumscribes the outer edge 109 of the flexible frame 105 when the flexible frame 105 is disposed within the receptacle cavity 125. The lining 130 may be configured to prevent the outer edge 109 of the flexible frame 105 from breaking and penetrating the housing 110 and may be made from a variety of suitable materials, including, but not limited to, fleece, buckram, and plastic. In an alternative embodiment, the housing 110 may be sealed at two or more ends to prevent the plurality of ends 108 of the flexible frame 105 from breaking and penetrating the housing 110. In another embodiment, the plurality of ends 108 may be connected together, such as shown in FIG. 9, to prevent the plurality of ends 108 from breaking and penetrating the housing 110. Further, in other embodiments, protective covers (not shown) may be placed over the plurality of ends 108 to prevent the plurality of ends 108 from breaking and penetrating the housing 110. The protective covers (not shown) may be made of any suitable material, such as plastic, rubber, and the like.

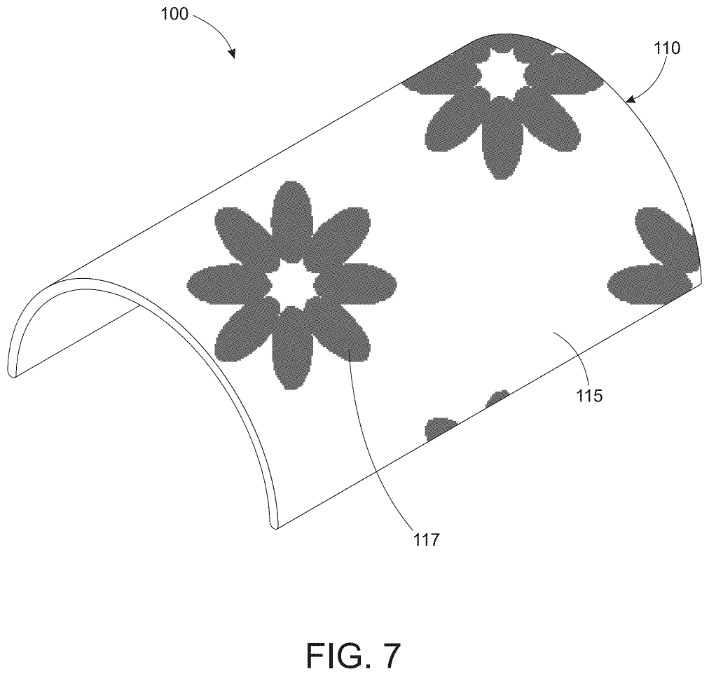

According to various embodiments, the exterior surface 115 of the apparatus 100 may comprise a marking 117 formed thereon, such as shown in FIG. 7. For example, in one embodiment, the marking 117 may comprise a flower pattern. Modifications may, however, be made to the marking 117 without departing from the scope of the invention. For example, the marking 117 as shown in FIG. 7 may instead comprise various symbols, colors, words, phrases, textures, or patterns. Further, the marking 117 may be formed on the exterior surface 115 of the apparatus 100 in any suitable manner, such as by printing, embroidering, embossing, debossing, or the like. Various other embodiments may include other markings, indicators, patterns, symbols, words, or other information.

The housing 110 may further comprise a cushion layer (not shown) for providing additional rigidity to the housing 110 and comfort for the pet. For example, the cushion layer (not shown) may provide insulation to keep the pet warm. The housing 110 may comprise any suitable size or shape such as a rectangular-shaped body, a square-shaped body, a circular-shaped body, or an oval-shaped body so long as the flexible frame 105 may fit within the respectable cavity 125 of the housing 110. Further, the housing 110 may be made of any material suitable for machine wash and dry so long as the material is considered to be pet-safe, meaning it is unharmful to the pet in the event the pet ingests the material. The pet-safe material may comprise any suitable material such as fleece, or any other combination of suitable materials.

In one embodiment, the flexible frame 105 may be fitted with an adjustable strap or flap assembly operable to connect two ends of the frame 105 to provide a holding tension therebetween, such as commonly used on adjustable ball caps. For example, in one embodiment, a first section of the frame 105 may be fitted with a hook and loop fastener which may adhere firmly to a conforming strip of hook and loop faster fitted to a second section of the frame 105. The flexible frame 105 may, however, be fitted with any suitable assembly operable to connect two ends of the frame 105. For example, in an alternative embodiment, the flexible frame 105 may be fitted with a zipper assembly operable to connect the two ends of the frame 105 to provide a holding tension therebetween.

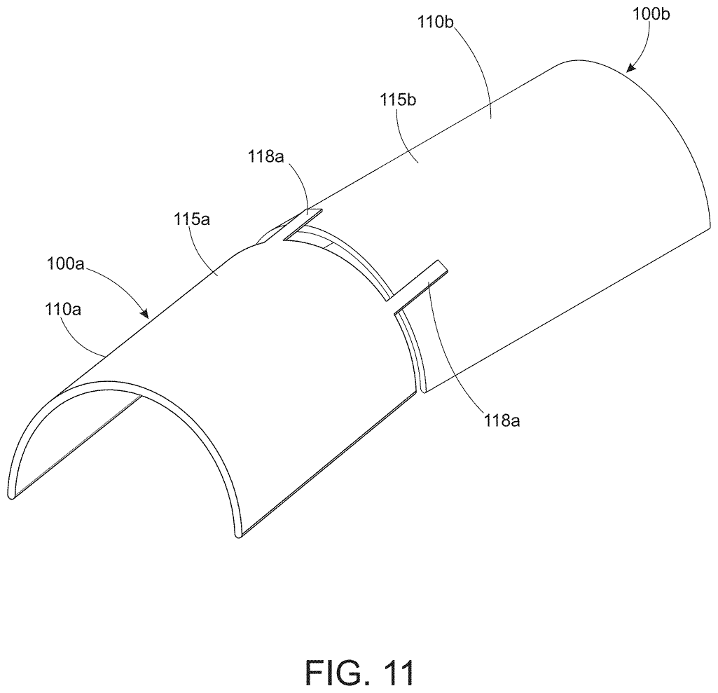

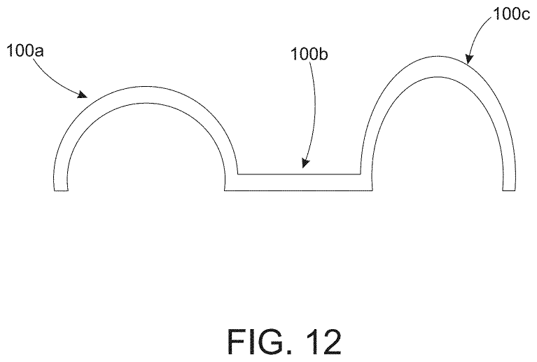

It will be appreciated that modifications may be made to the apparatus 100 without departing from the scope of the present invention. For example, the apparatus 100 may comprise stackable and interconnectable units. The units may be scalable and/or modular, and the system may allow for different movement pathways within or between the units. As an example, and referring now to FIGS. 11-12, a first housing 110a of a first unit 100a may comprise a first coupling component 118a configured to selectively engage and disengage a second exterior surface 115b of a second housing 110b of a second unit 100b. In addition, the second unit 100b may comprise a second coupling component (not shown) configured to selectively engage and disengage a first exterior surface 115a of the first housing 110a of the first unit 100a. Each coupling component may comprise at least one of a magnetic material, tongue and groove, button, snap, or hook and loop fastener.

The interconnectable units may be stacked and/or interconnected with each other in any suitable manner. For example, in one embodiment, the first unit 100a may be coupled to the second unit 100b and the second unit 100b may be coupled to a third unit 100c, such as shown in FIG. 12. Accordingly, the third unit 100c may comprise a third coupling component (not shown) configured to selectively engage and disengage the second exterior surface 115b of the second housing 110b of the second unit 100b. The second unit 100b, which may be a “mat” for use by the pet, may be filled with any suitable pet-safe batting material, such as cotton, polyester, or the like.

The particular implementations shown and described are illustrative of the technology and its best mode and are not intended to otherwise limit the scope of the present technology in any way. Indeed, for the sake of brevity, conventional manufacturing, connection, preparation, and other functional aspects of the apparatus may not be described in detail. Furthermore, the connections and points of contact shown in the various figures are intended to represent exemplary physical relationships between the various elements. Many alternative or additional functional relationships or physical connections may be present in a practical system.

Embodiments of the present technology may be used in conjunction with any number of pet apparatuses. In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system or apparatus embodiment may be combined in a variety of permutations to produce substantially the same result as the present technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

As used herein, the terms “comprise,” “comprises,” “comprising,” “having,” “including,” “includes,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the present technology, in addition to those not specifically recited, may be varied, or otherwise particularly adapted to specific environments, manufacturing specifications, design parameters or other operating requirements without departing from the general principles of the same.

1. An apparatus for use by a pet, comprising:
a flexible frame capable of being molded into a shape and configured to retain the shape; and
a housing configured to enclose the flexible frame and comprising:
an exterior surface; and
an interior surface defining a receptacle cavity in the housing and comprising a lining that circumscribes an edge of the frame when the frame is disposed within the receptacle cavity, wherein the lining is configured to prevent the flexible frame from penetrating the housing.

2. The apparatus of claim 1, wherein the flexible frame comprises:
a plurality of interconnected members, comprising:
a first member comprising a first hub; and
a second member axially connected to the first member and comprising a second hub in contact with the first hub; and
a connector comprising a locking component configured to constrain a movement of the first member with respect to the second member.

3. The apparatus of claim 2, wherein the locking component is further configured to disengage the first member from the second member.

4. The apparatus of claim 2, wherein the connector comprises at least one of a rivet, screw, or bolt.

5. The apparatus of claim 1, wherein the housing further comprises a coupling component comprising at least one of a magnetic material, adhesive, tongue and groove, button, snap, or hook and loop fastener.

6. The apparatus of claim 1, wherein the lining comprises at least one of fleece, buckram, or plastic.

7. A system for use by a pet, comprising:
a plurality of interconnectable units, wherein each unit comprises:
a flexible frame capable of being molded into a shape and configured to retain the shape; and
a housing configured to enclose the flexible frame and comprising:
an exterior surface; and
an interior surface defining a receptacle cavity in the housing and comprising a lining that circumscribes an edge of the frame when the frame is disposed within the receptacle cavity, wherein the lining is configured to prevent the flexible frame from penetrating the housing; and
a plurality of coupling components, wherein each coupling component is configured to selectively engage and disengage the exterior surface of the housing of one of the plurality of units from the housing of another one of the plurality of units.

8. The system of claim 7, wherein each coupling component comprises at least one of a magnetic material, adhesive, tongue and groove, button, snap, or hook and loop fastener.

9. The system of claim 7, wherein the lining comprises at least one of fleece, buckram, or plastic.

10. The system of claim 7, wherein the flexible frame comprises:
a plurality of interconnected members, comprising:
a first member comprising a first hub; and
a second member axially connected to the first member and comprising a second hub in contact with the first hub; and
a connector comprising a locking component configured to constrain a movement of the first member with respect to the second member.

11. The system of claim 10, wherein the connector comprises at least one of a rivet, screw, or bolt.

12. The system of claim 10, wherein the locking component is further configured to disengage the first member from the second member.
